(19) United States
(12) Patent Application Publication
(10) Pub. No.: US 2016/0141866 A1
(43) Pub. Date: May 19, 2016

(54) Fins And Foams Heat Exchangers With Phase Change For Cryogenic Thermal Energy Storage And Fault Current Limiters

(71) Applicant: Novum Industria LLC, New York, NY (US)

(72) Inventors: Leslie Bromberg, Sharon, MA (US); Philip C. Michael, Cambridge, MA (US)

(21) Appl. No.: 14/939,428

(22) Filed: Nov. 12, 2015

Related U.S. Application Data
(60) Provisional application No. 62/079,901, filed on Nov. 14, 2014.

(51) Int. Cl. H02H 9/02; F28D 20/00

(52) U.S. Cl. CPC H02H 9/023; F28D 20/0034

(57) ABSTRACT

This disclosure describes a composite device that is referred to as a Cryogenic Thermal Energy Storage Module (CTESM), which can be used to substantially increase the thermal storage capacity of a cryogenic device. To maximize the utility of the CTESM, it needs to be constructed in such a way that the thermal gradient through the device is low. Ideally, the temperature across the thermal storage module should be uniform. Heat flow from the bulk of the thermal storage module is provided by embedding fins in the direction of heat flow from the module to the cryogenic device. Temperature gradients across the device are minimized by partially filling the gap between fins with high porosity, thermal conducting metal foams.

This application claims priority of U.S. Provisional Patent Application Ser. No. 62/079,901, filed Nov. 14, 2014, the disclosure of which is incorporated herein by reference in its entirety.

### FIELD

Embodiments of the present disclosure relate to cryogenic systems, and more particular to a component that can be used to substantially increase the thermal storage capacity of a cryogenic device.

### BACKGROUND

Cryogenic devices, such as superconducting magnets, superconducting electric power transmission and distribution systems, and other superconducting electrical cables, are cooled to and maintained at their operating temperatures by cryogenic cooling systems, such as cryorefrigerators or cryocoolers. Depending on application, the cooling systems use various combinations of: a) liquid cryogens, b) gaseous cryogens, c) cryocirculators, and/or d) one or more cryocoolers. Liquid and gaseous cryogens may or may not be actively circulated through the device. Cryocoolers may be in contact with either the device or the cryogens. During operation of the device, the cooling system works to remove heat generated within and transferred to the device from the ambient environment.

Often a cryogenic device is designed and manufactured so that it can safely operate over a certain temperature range. For example, a temperature range of 1.8K-8K is applicable to devices like superconducting magnets that use Nb—Ti superconductors. A temperature range of 1.8K-15K is applicable to devices like superconducting magnets that use Nb₃Sn superconductors. A temperature range of 10K-25K is applicable to devices like superconducting magnets or electric power transmission cables that use MgB₂ superconductors. A temperature range of 20K-65K is applicable to devices like superconducting magnets, electric power transmission cables, or superconducting current leads that use high temperature superconductors (HTS). Some devices are designed for continuous operation and continuous cooling, while others operate in pulsed mode.

Examples of cryogenic devices designed for intermittent cooling include the floating magnets for plasma physics experiments like the Mini-RT device at University or Tokyo and the Levitated Dipole Experiment (LDX) at MIT. The floating coil for the Mini-RT uses HTS, while the floating coil for the LDX uses Nb₃Sn. At the start of an experimental run, the floating coil is cooled to its working temperature, by conduction to a cryocooler cold head (Mini-RT) or by liquid helium transfer (LDX). During experimental operation, the coils are disconnected from their cooling sources and warm gradually, with temperature rise determined by the heating rates and by the enthalpy of stored, on-board cryogens. The coils must be returned to their charging station either to be re-cooled or discharged, before their limiting superconducting temperature is reached. Improvement to the thermal storage capacity of either device, for instance, by embedding the coils in thermal energy storage modules, can greatly increase the available use time between recooling.

A superconducting magnetic energy storage (SMES) system is one example of a cryogenic device designed for intermittent operation. A SMES could operate in persistent mode, where the magnet current is recirculated through the device entirely within the cryogenic environment, by use of a persistent current switch. During this mode of operation, no current flows through the leads that connect the SMES to the ambient environment, and the cryogenic heat load is minimal. The cooling power to the leads must necessarily increase when current is drawn out from the SMES, to accommodate increased resistive dissipation and thermal conduction in the leads. Because the total energy stored in the SMES is limited, the maximum duration of current draw is also well defined. The required cooling during pulsed operation of the leads can be provided by integrating thermal energy storage modules at strategic locations along the leads.

For devices designed for steady state operation, there is always the possibility that the cooling system for the device may malfunction. In the event of cooling device malfunction, heat removal slows, or ceases, and the device warms toward its limiting superconducting temperature. If cooling cannot be restored, any current in the device must be removed before the critical superconducting limit is reached to avoid damage to the superconductor. The heat capacity of the cryogenic device determines how long the device can stay in operation following a cooling system malfunction. The heat capacities for most of the materials used to build cryogenic devices are not particularly high. For a thermally robust design, the heat capacities of cryogenic devices can be markedly increased using materials that have high ratios of heat capacity to volume. The time available to safely discharge current from a malfunctioning device can be significantly extended by increasing the thermal capacity of its most critical components, while minimizing the corresponding temperature rise.

Therefore, it would be beneficial if there were a system that can be used to substantially increase the thermal storage capacity of a cryogenic device.

### SUMMARY

This disclosure describes a composite device that is referred to as a Cryogenic Thermal Energy Storage Module (CTESM), which can be used to substantially increase the thermal storage capacity of a cryogenic device. To maximize the utility of the CTESM, it needs to be constructed in such a way that the thermal gradient through the device is low. Ideally, the temperature across the thermal storage module should be uniform. Heat flow from the bulk of the thermal storage module is provided by embedding fins in the direction of heat flow from the module to the cryogenic device. Temperature gradients across the device are minimized by partially filling the gap between fins with high porosity, thermal conducting metal foams.

### BRIEF DESCRIPTION OF THE FIGURES

For a better understanding of the present disclosure, reference is made to the accompanying drawings, which are incorporated herein by reference and in which:

FIGS. 1A-1B shows thermal energy storage modules comprised of high conductivity metallic fins, with gaps between fins filled with high porosity, thermal conducting metallic foam. The fins are arranged in the intended direction of heat flow and thermally connected to a high thermal conductivity mounting plate. The foam is filled with phase change material of appropriate transition temperature, mounted inside a cryogenic device and cooled to the designed use temperature. FIG. 1A shows a thermal energy storage module intended for conduction cooled application. FIG. 1B shows a thermal energy storage module designed to permit flow of circulating cryogen through the module.

FIG. 2 shows a concept of modular cryogenic thermal storage with possibility of non-isothermal operation (some of the modules at high temperature, some at low temperature, with flow controlled by valving).

FIG. 3A shows multiple cryogenic thermal storage modules mounted along the length of a current lead, where the current lead is normal conducting. FIG. 3B shows multiple cryogenic thermal storage elements mounted along the length of a current lead, where the current lead is normal conducting at the higher temperatures, and superconducting at the lower temperatures.

FIG. 4 shows a cryogenic energy storage element with a dedicated cryocooler.

FIG. 5 shows foam on tapes for providing high heat removal and high cooling capacities.

FIG. 6 shows a foam/fin configuration.

FIG. 7 shows the thermal diffusivity of solid copper.

### DETAILED DESCRIPTION

The present disclosure describes the design and manufacture of systems that use of phase change materials for thermal storage with improved heat exchange at cryogenic temperatures. The term cryogenic temperatures, as used within this disclosure, refers to a temperature below 100K. The most desirable materials have high latent heat (due to a first order phase transition) at, or near, the desired cryogenic use temperature. The proposed thermal storage materials for this invention are typically either liquids or gases near room temperature and solids or liquids at cryogenic temperatures. In some cases, there is phase change to increase the enthalpy capability with small temperature excursion. To enhance thermal conductivity, the phase change material is embedded in an extended heat exchanger consisting of continuous fins in the desired direction of heat flow, with the gaps between fins filled with high porosity, thermal conducting metal foams that are thermally well connected to the fins. The use of the extended foam/fin structure greatly improves accessibility to the stored thermal energy throughout the bulk of the device. The use of high porosity foams maximizes the fraction of phase change material in the device. The thermal energy storage module is enclosed inside a leak-tight boundary to contain the phase change material at room temperature.

This invention is based on a composite structure comprised of a network of high conductivity metal fins embedded in a solid matrix of phase change material. The fins are oriented in the intended heat transfer direction, and gaps between fins are bridged by high porosity, thermal conducting metal foams. The metallic foam is filled with a thermal storage material. The assembly is enclosed in a leak-tight vacuum boundary to contain the thermal storage material, which could undergo a phase change, and to permit installation within the vacuum space inside a cryogenic device. If the material undergoes a phase change and becomes gaseous at room temperature, the leak-tight vacuum boundary holds the phase change gas at high pressure when at room temperature. The phase change material increases the effective thermal capacity at select locations within the cryogenic device while effectively limiting the temperature rise at those locations during periods of high thermal load. The device should be particularly effective in enhancing the thermal stability of superconducting systems subject to pulsed current operation, or in prolonging the available response time to react to malfunction of the primary cooling system.

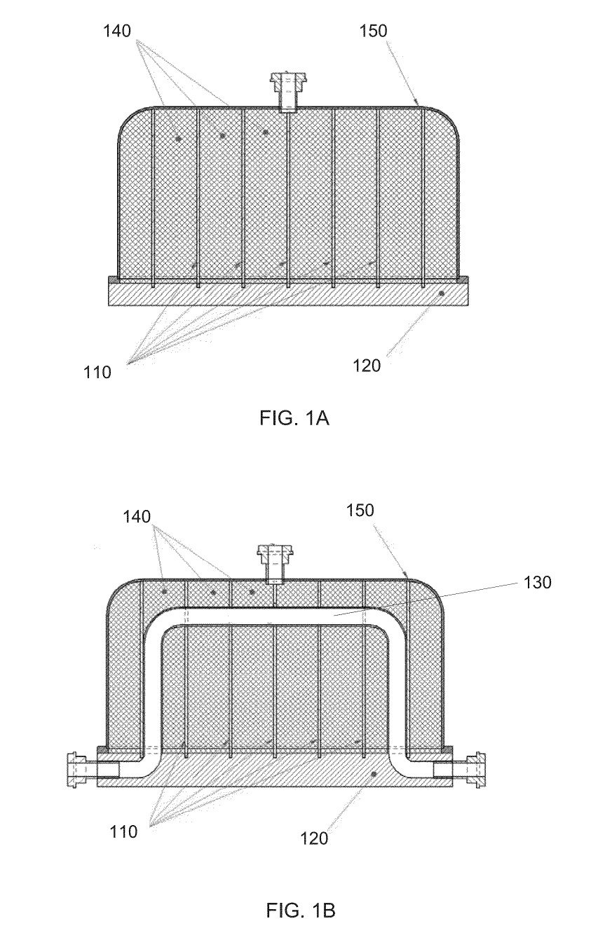

FIGS. 1A-1B show examples of useful thermal storage modules. Each module is enclosed in a leak-tight vacuum boundary 150 to contain the thermal storage material. Heat transfer to the module depicted in FIG. 1A is by thermal conduction to or from the mounting plate 120, while heat transfer to the module shown in FIG. 1B is by principally by convection to either a circulating gas or circulating liquid cryogen, which flows through a cooling channel 130 that passes through the device. Each CTESM is comprised of several high thermal conductivity fins 110, with gaps between the fins bridged by high porosity, thermal conducting metallic foam 140. In certain embodiments, the metallic foam 140 may have a porosity greater than 85%. In other embodiments, the porosity may be greater than 90%. The metallic foam 140 in FIG. 1B is thermally attached to the fins 110, which, in turn, are thermally attached to the cooling channel 130. The foam 140 may also be thermally attached to the cooling channel 130. The foams 140 are saturated with and effectively exchange heat with phase change material (either solid, liquid or gas). However, because of the high porosities of the metallic foams, their effective thermal conductivities are low. The fins 110 serve to conduct the heat to or from the element to be cooled and transmit it to the foam 140. The foam is effective to transfer heat to liquids, gases or solids (because of the high surface to volume ratio). Foams can effectively transfer heat to a solid filler, which because of differential thermal contraction, would otherwise develop a network of through cracks due to the large thermal strain. Without the foam to bridge these cracks, the effective thermal conductivity of the phase change material would be substantially reduced.

The foams 140 should be well bonded to the fins 110. To increase the metal fraction near the region of contact between the foams 140 and the fins 110, the foam material can be locally compressed. This can be done by applying pressure through a small dye in very small regions of the foam (on the order of the dimension of the open cells), so that the pore walls under the dye collapse locally. The applied load becomes better distributed with distance away from the surface of the foam. The deformation occurs mostly near the surface, decreasing the porosity of the foam only locally. The increased density at the surface aids in achieving adequate thermal contact between the foam and the fins.

The choice of bonding agent depends on the temperature. For cryogenic temperatures, bonding with epoxies is possible and effective. Alternatively, solder or brazing agents can be used. To achieve better contact, the surface of the fin can be modified. Small depressions, regular or irregular, can be filled with the solder or the brazing compound. The foam surface, in the region that faces the fin, can also be coated with appropriate material. It is possible to have flux on the foams, while the brazing compound or solder is on the fin.

Multiple open cell geometries can be used for the foams. Usual porosity of commonly available open cell metallic foams is 90-95%. Pore cells dimensions are 5-20 per linear inch, or 25-400 cells per square inch. These materials are available in copper, aluminum, nickel and a range of other materials, including ceramics (SiC, for example). Materials with high thermal conductivity, such as copper or aluminum, are preferred for cryogenic applications.

The foam and fin assembly is connected to a high thermal conductivity mounting plate 120 at one end and enclosed within a leak tight boundary 150. The module is mounted at a critical location within the cryogenic system, filled with a suitable phase change material depending on the designed operating temperature and cooled to the cryogenic system's intended operating temperature. For example, the phase change material may be selected so that it undergoes a phase change at a temperature close to the system's intended operating temperature. It is known that cryogenic materials, such as nitrogen, undergo a change in volume when they solidify, resulting in cracks that prevent effective thermal conduction through the bulk solid of nitrogen. By placing the nitrogen (or other phase change material) in a metallic matrix, the cracked thermal storage material will remain effectively attached to the metallic foam.

Examples of suitable phase change materials are shown in Table 1 and include all of the common cryogenic liquids, such as hydrogen, neon, oxygen, nitrogen, argon, light hydrocarbons (methane, ethane, propane) and mixtures of these. The accessible range of transition temperature is greatly enhanced when working with binary mixtures of cryogens. Table 1 shows the latent heat and corresponding transition temperatures for some of the phase change materials of interest. The phase transitions of interest include both those that occur from one solid phase to another or between solid and liquid. Propane is particularly interesting, in that the pressure required to maintain liquid state at room temperature is <10 bars.

Although not specifically a cryogenic liquid, water is included in Table 1, as an example of a material that can be used to increase the thermal capacity near the upper temperature end of a link between the cryogenic device and the ambient environment. The current leads to a superconducting device are one example of one of this type of link.

TABLE 1
Melting temperature and latent heat (J/g) for several
phase change materials of interest

| | | Temperature | Latent heat |
|---|---|---|---|
| Substance | Transition | [K] | [J/g] |
| Hydrogen | Solid to liquid | 14 | 58 |
| Neon | Solid to liquid | 24.4 | 16.3 |
| Nitrogen | α to β solid | 35.6 | 8.2 |
| Oxygen/nitrogen | Solid to liquid | 50 | ???? |
| eutectic | | | |
| Oxygen | Solid to liquid | 54 | 13.9 |
| Nitrogen | Solid to liquid | 63 | 25.7 |
| Argon | Solid to liquid | 84 | 29.6 |
| Propane | Solid to liquid | 85 | 80 |
| Methane | Solid to liquid | 95 | 59 |
| Ethane | Solid to liquid | 101 | 95 |
| Ethanol | Solid to liquid | 159 | 108 |
| Water | Solid to liquid | 273 | 334 |

Other materials can be used in cryogenic applications. There is a range of organohalogens/halocarbons that have phase changing temperature attractive to cryogenic applications, in the range between 120K and 200K (such as 2-chloro butane, ethyl chloride).

By increasing the surface area using foams, nucleate boiling, during the transition from liquid to gas can be extended. There may be bubbles forming on the surface of the foam and the fins, but the system is more tolerant to burn-out heat flux conditions when the surface of the element to be cooled (in the absence of the fin and the foam) is covered by a continuous film of gas and the heat transfer is reduced dramatically over that with liquid. In the case with the foam and fins, bubbles initiate at higher heat removal rates from the element being cooled than in the absence of the foam or fins. Further, the region impacted by the generation of the bubbles is substantially larger, allowing for increased total energy absorbed by the system (in the case of liquid to gas, or solid to gas).

In addition to cryogenic uses, where the composites are used for cooling components, similar technology can be used as heaters, where the device is used to maintain components at elevated temperatures. Elements for heating applications are likely to be at higher temperature than elements used for cooling (and in particular, cryogenic cooling).

A main point of this invention is to form efficient CTESM based on a composite structure whose major part is a phase change material, and whose minor part is a heat conducting material that is dispersed within the solid/liquid cryogen.

Another main point of this invention is that the modules, such as that shown in FIGS. 1A-1B, can be any size or shape. The modules may be combined and/or arranged to satisfy various levels of cryogenic thermal storage needs. Depending on application, the modules could be integrated within the cryogenic system cooling loop, or they could be directly mounted to enhance the thermal capacity of a critical component and cooled indirectly by heat transfer to the critical component.

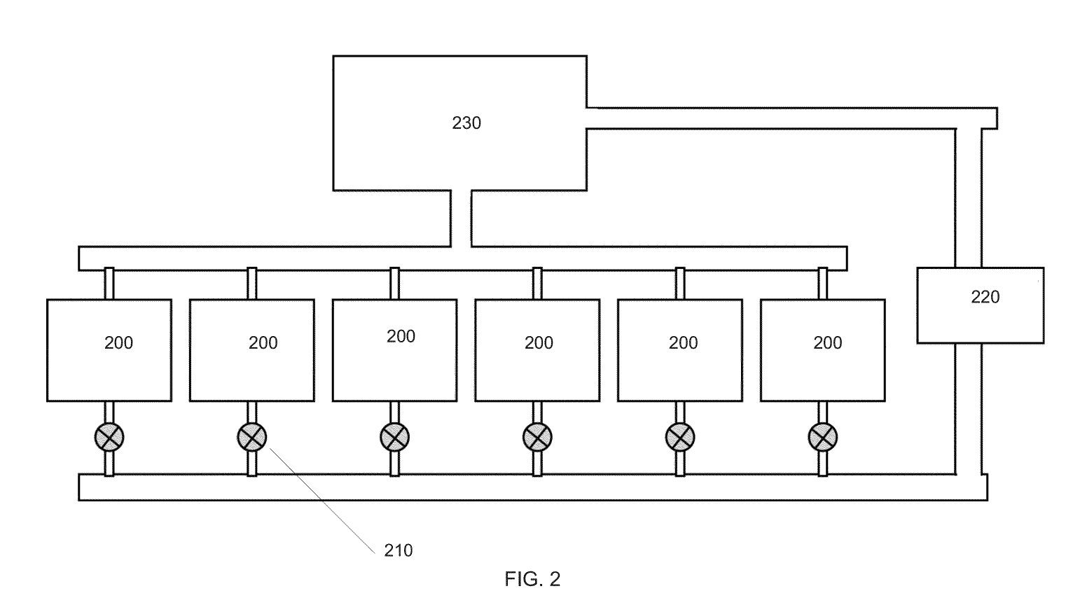

FIG. 2 shows one possible configuration of multiple modules 200 assembled together within the same cryostat. Each module 200 is contained within its own hermetic boundary and cooled to a slightly different temperature than the neighboring module, with valving 210 to direct the flow of cryogenic coolant through the circulator 220 to the appropriate module 200. The unit could share the same cryostat as the cryogenic device 230, or have its own cryostat. The arrangement could be used to minimize input power to a cryogenic system subject to intermittent operation at different cryogenic temperatures.

In addition, cryogenic thermal storage modules of this invention are useful when they are integrated with current leads that connect the current terminals of a superconducting magnet from the room temperature part of the magnet system to its cryogenic part. In this application, the cryogenic thermal energy storage module absorbs the electrical resistive heat that the current leads generate and that is conducted along the current lead.

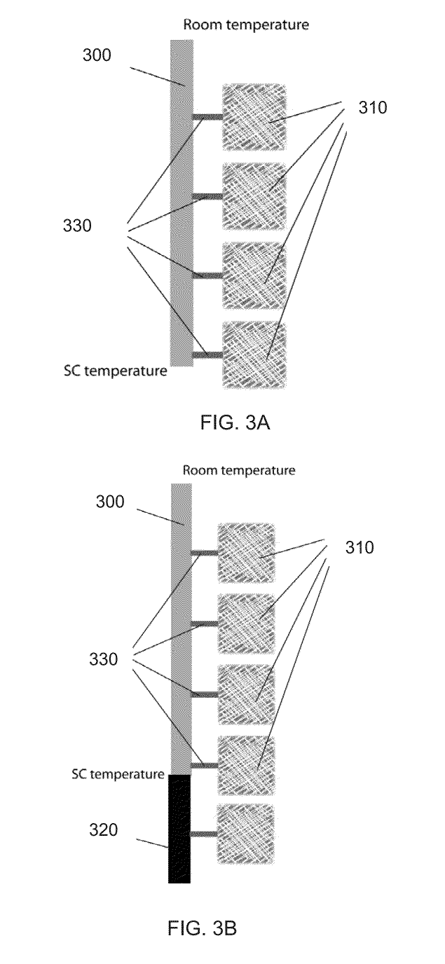

In FIGS. 3A-3B, the top part of the current lead is at room temperature, while the bottom portion is at cryogenic temperatures. FIG. 3A shows a schematic of a normally conducting current lead 300 with multiple CTESMs 310, with different compositions at the different temperatures. Thermal shunts 330 connect the CTESMs 310 to the normally conducting current lead. FIG. 3B shows a case where the current lead includes a normally conducting current lead 300 and a superconductor portion 320 where superconducting elements are used in the current lead. The temperatures of the different CTESMs 310, during steady state, are at the same temperature as the current lead, as they can be cooled by the current lead. However, if there is a failure of the cryogenic cooling devices or an overcurrent in the current leads, the CTESMs 310 can absorb energy, preventing a change in temperature of the current lead during the phase transition of the materials of the CTESMs. Because a phase change material is used for the thermal energy storage media in FIGS. 3A-3B, the temperature of the module would remain near constant until the phase transition was complete, at which point the temperature at that location would begin to rise based on the heat capacity of the media in the elevated temperature state.

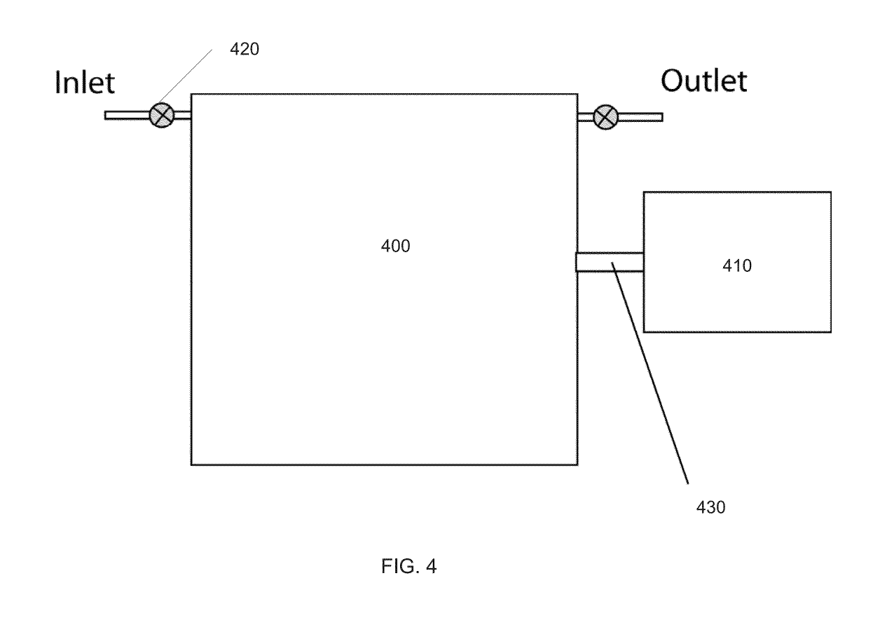

An alternative, shown in FIG. 4, has a compact chiller, which may be a cryocooler, such as compact Stirling cryocooler, with limited capacity. The cryogenic thermal energy storage module 400 is cooled slowly by the dedicated cryocooler 410, which is in thermal communication through the use of thermal shunts 430. The cryogenic thermal energy storage module 400 is maintained at this temperature by the cryocooler 410. The temperature of the cryogenic thermal energy storage modules 400 is lower than that of the cryogenic device that is being cooled. In this manner, it is possible to absorb a limited amount of energy in the CTESM 400 without raising the temperature of the cryogenic device. The cryogenic thermal energy storage system 400 can be engaged by the use of valves 420 or other types of systems, such as a cryogenic thermal switch.

Although the presence of a filler material in the metallic foams (either solid, liquid or gaseous) has been described, it is possible to use a composite. One possibility is the use of a composite that includes hollow glass microspheres. These microspheres have been suggested as thermal insulation, the opposite goal of the proposed approach. These hollow microspheres can be filled at elevated temperature with a gas at high pressure (such as hydrogen or helium, gases that have high permeability through glass at temperatures that the glass microspheres can tolerate). The hollow glass microspheres can hold gas at high pressures without breaking. The gas filled micro spheres are mixed with a matrix material, such as an epoxy, and the mixture is flowed into the metallic foam. The foam on fin approach, filled with a composite with epoxy and gas filled microspheres, achieves the goal of high thermal conduction and high heat capacity. When at cryogenic temperature, the material inside the hollow microspheres is partly in either the liquid or solid phase.

### Fault Current Limiters

One application of the invention described in this document is to increase the heat removal rate and total energy removed from superconducting, electrical power system components. In particular, the use of Fault Current Limiters (FCL) is frequently proposed, where the superconducting-to-normal transition is used to limit the magnitude of the peak current in a transmission or distribution system during fault conditions. The large voltage drop across the FCL prevents damage to components on the line or elsewhere in the system. However, during the fault, substantial thermal capacity is needed in the FCL element, which is generally cooled in a bath of liquid cryogen. If the heat load is not effectively removed, the system can progress to burn-out conditions, where the evolved cryogen gas collects in a limited region of the system, reduces the heat transfer rate, and the local region experiences large thermal excursions that can damage the FCL.

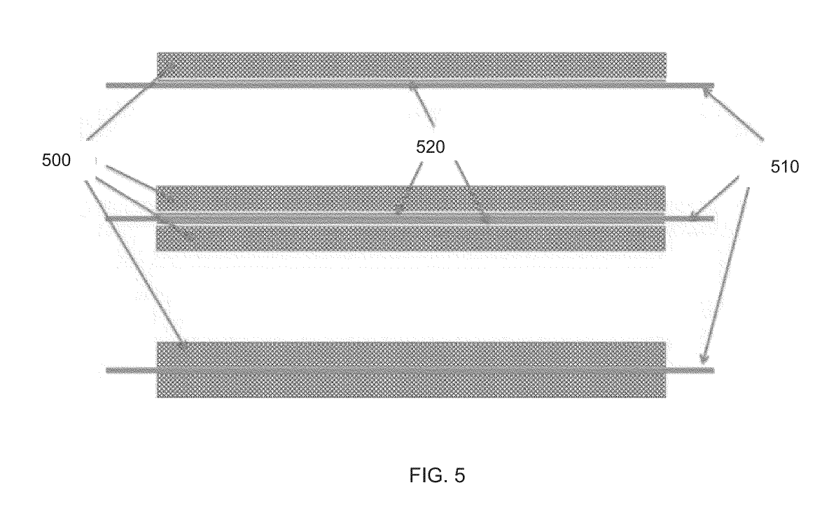

FIG. 5 shows a potential implementation of the topology combining a thermal energy storage element with a superconductor cable used for applications such as FCL. FIG. 5 shows the thermal energy storage element 500 attached along the entire length of the tape 510 that acts as the FCL. In the case of the 2^{nd}-generation HTS tapes, the thermal storage material can be thermally attached to either silver, copper or stainless sheaths that cover the superconductor elements.

In the case of cables made from strands or tapes, the thermal energy storage element 500 can be attached to one or both sides of the superconductor cable 510. The energy storage elements (in the form of foams or foam/fins, both with liquid or solid inside, can be attached to the edges of the superconductor cable 510 so that they are in contact with the edges of all the elements of the cable. The cables can be made from HTS tapes like REBCO (including YBCO and other compounds), as well as BSSCO 2223.

To increase the resistance of the normal zone in the HTS FCL, it is desirable to minimize the amount of current-carrying copper or other conductor in the tape, and some cases, eliminate it altogether. One particular vendor, Superpower, manufactures wide tapes without copper coating, with a 50 micron Hastelloy substrate and a thin silver coating, on the order of 1 micron. The foam would be attached to either the Hastelloy or the thin silver side of the tape, or to both sides.

In addition to assisting with heat removal during the time when there is a fault or when energy needs to be removed, the present application also assists in the recooling process, by providing a near isothermal energy storage element, effectively decreasing the entropy generation during recooling, or in the case of a FCL, “recovery” to the superconducting state.

The foam on tape concept can be used to provide improved thermal contact between superconducting tapes and a cooling media that surrounds the tapes. Under the conventional method where the tape without the foam is in a bath, when a section of the tape transitions to the normal, or resistive, state the heat flux could be very high, possibly above the peak nucleate boiling heat flux, potentially destroying the tapes because of excessive temperature. In the case of phase change from solid to liquid, the coolant can go beyond liquid and into the gaseous phase.

In the case of phase change from liquid to gas with the foam, bubbles in the foam could prevent cooling of the foam by the bath. Once the volume of the foam is filled with gas, it would stop effectively cooling the foam and thus the tape. However, because of the much larger volume and the large surface area within this volume, the system can absorb substantially higher heat loads than the tapes or cables without the foam. Further, the enthalpy from solid through the phase change to liquid and then to gas is much higher than what available from liquid to gas without the presence of the foam.

The phase change to gas can be prevented by operating the coolant above its critical pressure, so that fluid is supercritical. However, for the case of an isolated superconductor tape, there is still limited thermal transfer between the tape and the coolant, due to the small surface of contact. The area of contact between the FCL and its coolant can be substantially increased by using a foam that is thermally attached to the superconducting tapes for the fault current limiter.

The foam 500 can be electrically insulated from the tapes, or the foam can be both electrically and thermal attached to the tapes, as shown in FIG. 5. To minimize current shunting through the foam, it may be desirable to have an electrically insulating layer 520 between the tape and the foam.

For the case of fault current limiters, it is desirable to have high resistance of the superconductor component during the fault, to maximize the voltage. A 1 cm thick copper foam, with 85% porosity, has an equivalent thickness (solid) of about 1.5 mm, much thicker than the copper that surrounds the HTS tapes (in practice the effective thickness of the foam is less than this, as the struts in the foam are aligned in all directions, some of which are not effective at carrying current). Thus, in the case of copper, it is desirable to electrically insulate the foam from the tape. In the case of steel, with a resistivity more than 2 orders of magnitude higher than copper, a 1 cm thick foam would have an equivalent thickness (relative to copper) of about 10 microns. A thin electrical insulator can be used to prevent currents from flowing in the foam/fins composite. The electrical insulation is in good thermal contact with the superconducting element and with the foam. A thermally conducting epoxy or similar material can be used to provide good thermal contact (but no electrical contact) between the foam/fin and the superconducting element.

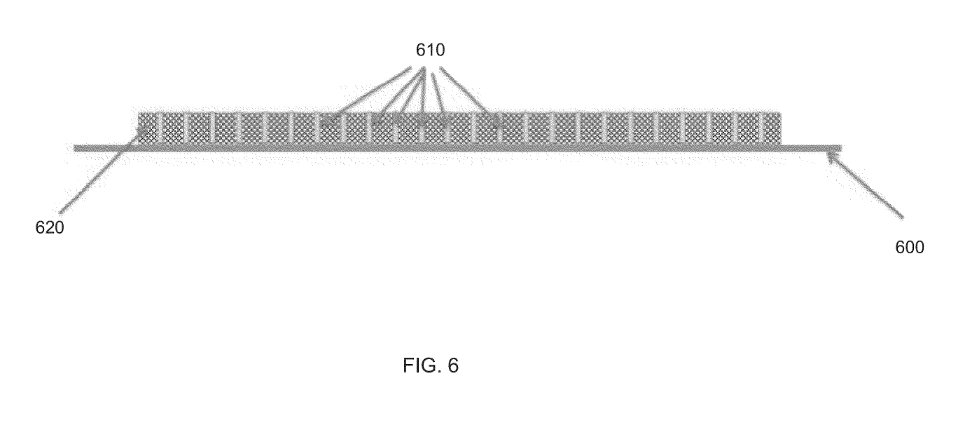

A foam-fin configuration is shown in FIG. 6. In FIG. 6, the foam/fin composite can be electrically connected to the tape 600, or it could be electrically insulated from the tape 600. The foam/fin could be on one side of the tape 600, or it could be on both sides. The fins 610 can be cylinders, plates or other geometries that are as wide as the foam 620 and can be used to increase the thermal conductivity in the direction away from the tapes 600.

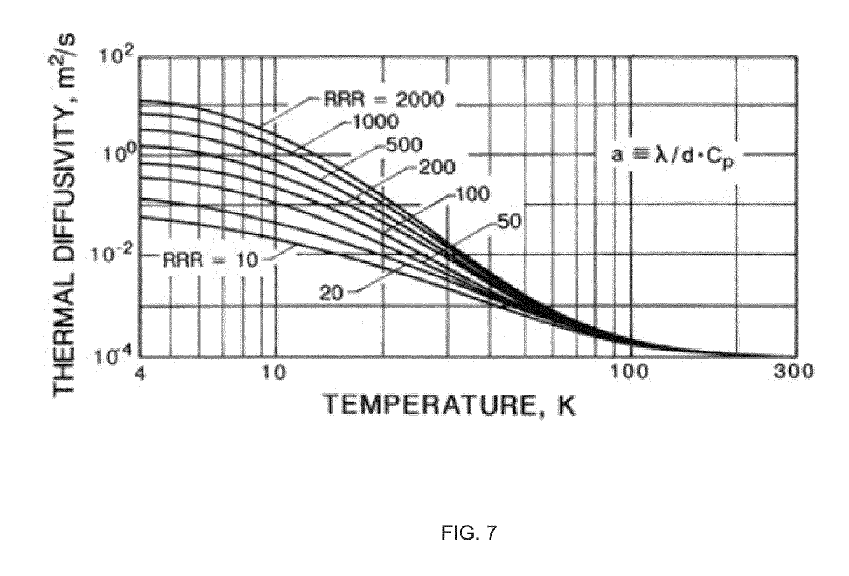

Thermal diffusivity is defined as α=k/ρc, where k is thermal conductivity, ρ is density and c is specific heat capacity. FIG. 7 shows the thermal diffusivity for copper as a function of both purity (RRR) and temperature. A metallic foam with a porosity of ε, has a thermal diffusivity that is approximately represented by αₚₒᵣₒᵤₛ=α_{solid}*(1−ε). For a copper foam with 85% porosity, the thermal diffusivity, at 20 K of the copper, is about 30 cm²/s. For a 1 cm thick foam, the time constant for the heat to distribute through the foam is thus about 30 ms, or about 2 cycles of the AC (assumed to be 60 Hz). If the foam thickness is only about 5 mm, then the time constant is approximately half-a-cycle of 60 Hz. The time constant is thus short enough to prevent the destruction of the tape. In the case of foam/fin configuration, the time constant is substantially decreased, because of the much larger effective thermal conductivity provided by the fins.

In the case of solid substance for storing thermal energy for protection of the fault current limiter, it is known that cracks in the solid can modify the thermal conductivity substantially, preventing the heat from flowing through the substance surrounding the tapes. The use of foams avoid this problem, as even if there are cracks introduced in the solid substance, the thermal conductivity is still dominated by the foam, and as a consequence, the heat capacity of the composite remains available to minimize the thermal excursion of the superconductor during a fault.

It is possible to eliminate the thermal insulation between the element being cooled and the fin/foam composite, for applications where the current flowing through the foam/fin is not deleterious to the application. For FCL applications, current flowing through the foam/fin composite would decrease the resistance across the element. There are applications where the reduced resistance (and associated voltage drop) can be designed into the system.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A thermal energy storage module, comprising:
a thermally conductive wall in contact with an object to be cooled or warmed to a desired temperature;
solid fins attached to the thermally conductive wall;
metallic foam bonded to the solid fins and interspaced within the fins;
a filler material in solid contact with the metallic foam, wherein the filler material is capable of undergoing a phase transition at a temperature close to the desired temperature.

2. The thermal energy storage module of claim 1, where the desired temperature is below 100K.

3. The thermal energy storage module of claim 1, wherein the phase transition is from solid to liquid.

4. The thermal energy storage module of claim 1, wherein the fins, the metallic foam and the filler material is enclosed in a vacuum enclosure.

5. The thermal energy storage module of claim 4, wherein the object to be cooled or warmed is also enclosed within the vacuum enclosure.

6. The thermal energy storage module of claim 1, wherein the metallic foam is compressed in areas that contact the solid fins.

7. The thermal energy storage module of claim 1, wherein the metallic foam comprises copper or aluminum.

8. The thermal energy storage module of claim 1, wherein the metallic foam has a porosity of greater than 85%.

9. The thermal energy storage module of claim 1, further comprising a cryocooler to maintain a temperature of the thermal energy storage module at or below the desired temperature.

10. A thermal energy storage module, comprising:
a vacuum enclosure;
a cooling channel passing through the vacuum enclosure;
solid fins attached to the cooling channel;
metallic foam attached to the solid fins and interspaced within the fins;
a filler material in solid contact with the metallic foam, wherein the filler material is capable of undergoing a phase transition at a temperature close to a desired temperature of interest.

11. The thermal energy storage module of claim 10, where the desired temperature of interest is below 100K.

12. The thermal energy storage module of claim 10, wherein the phase transition is from solid to liquid.

13. A fault current limiter, comprising:
a HTS tape for conducting current;
a metallic foam in contact with the HTS tape; and
a filler material in solid contact with the metallic foam, wherein the filler material is capable of undergoing a phase transition when a fault condition occurs, wherein the HTS tape, the metallic foam and the filler material are disposed in a vacuum enclosure.

14. The fault current limiter of claim 13, further comprising fins in contact with the HTS tape.

15. The fault current limiter of claim 13, wherein the filler material is electrically isolated from the HTS tape.
